(19) United States
(12) Patent Application Publication
(10) Pub. No.: US 2011/0061356 A1
(43) Pub. Date: Mar. 17, 2011

(54) DEVICE FOR SUPPLYING A LEAF-STRIPPING DEVICE WITH TOBACCO PLANTS

(75) Inventor: Didier Jacques THER, Boulazac (FR)

(73) Assignees: SOCIETE COOPERATIVE AGRICOLE DES PLANTEURS DE TABAC, PERIGORD, SAINTOGE,; AUVERGNE, LIMOUSIN DITE PERIGORD TABAC, Trelissac (FR)

(21) Appl. No.: 12/844,924

(22) Filed: Jul. 28, 2010

(30) Foreign Application Priority Data
Jul. 28, 2009 (FR) 09 55285

(51) Int. Cl. A01D 45/16

(52) U.S. Cl. 56/27.5

(57) ABSTRACT

A supply device (30) of a device (10) for stripping leaves from tobacco plants P, where each plant is composed of a stem T that bears leaves F. The leaf-stripping device (10) includes at least one station (12) for supplying tobacco plants P, a discharging station (14), and elements (16) for transferring the plants P from the supply station (12) to the discharging station (14) according to a direction S of work. The transfer elements (16) include elements for receiving plants P at the supply station (12). The supply device (30) includes elements for depositing the tobacco plants P on the receiving elements of the leaf-stripping device (10) and elements for bringing the plants P for their leaves to be stripped one after the other and in an automated manner to the supply station (12) of the leaf-stripping device.

This invention relates to the supply of a leaf-stripping device with tobacco plants, and more particularly a leaf-stripping device with a high working speed.

After the harvest, tobacco plants are generally put out to dry in a dryer.

During this drying stage, the tobacco plant is preserved in the form of a stem that comprises different foliar stages.

Subsequently, the leaf-stripping of the tobacco plants takes place when said plants have reached a given degree of drying, monitored by the producer.

This leaf-stripping therefore consists in separating the leaves from the stem of each plant, preferably by avoiding mixing the leaves that are obtained from different foliar stages of the plant and by implementing a sorting to eliminate rotted or fermented leaves.

According to a first method, this leaf-stripping can be conducted manually by several farm workers.

Although justifiable in terms of quality, manual leaf-stripping takes too long and is too expensive for the tobacco producer, and in addition, the manual labor for this type of work is increasingly difficult to find.

Consequently, automated leaf-stripping devices have been developed so as to reduce the time and the manual labor necessary for this operation.

For example, a first leaf-stripping device that is described in the French Patent Application FR 08 55200 in the name of the same applicant is known.

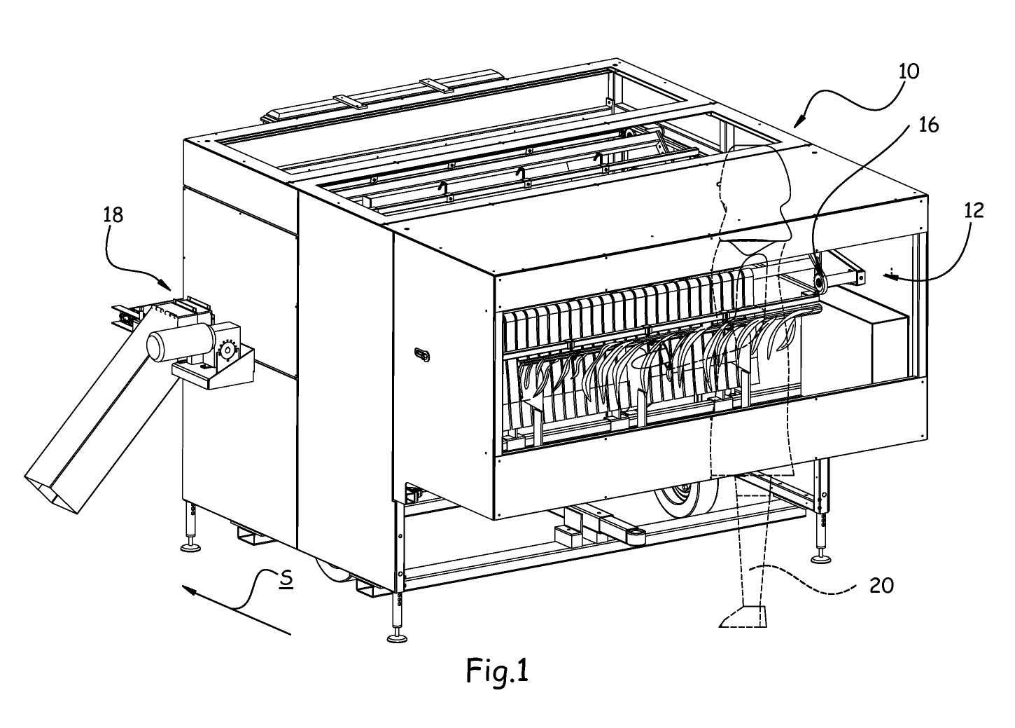

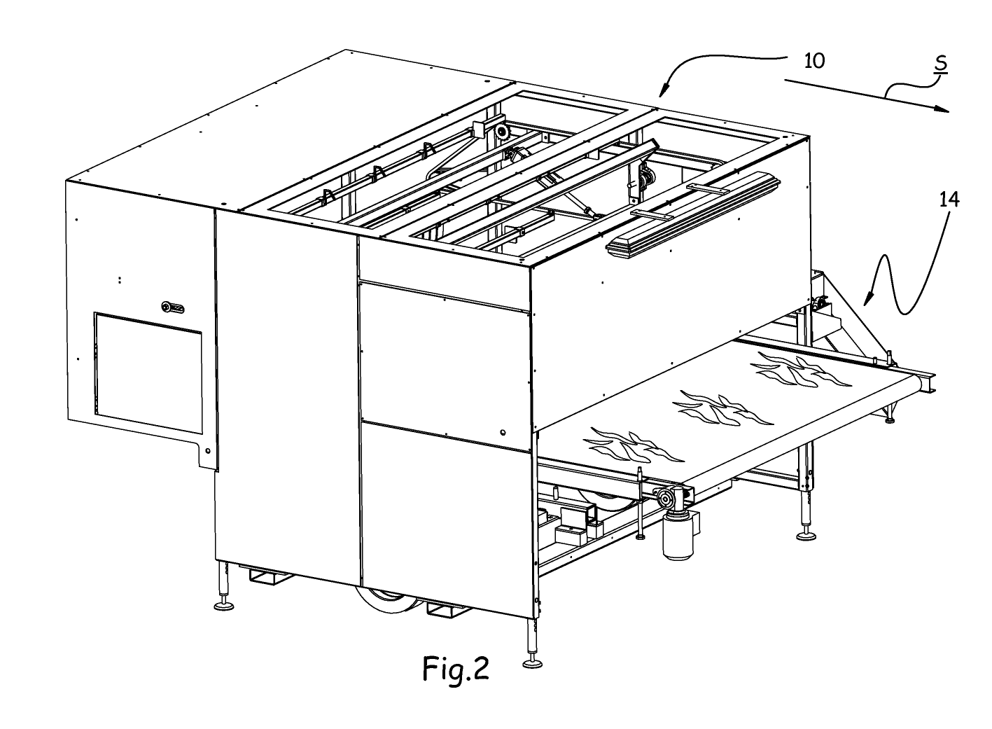

This first leaf-stripping device 10 of the prior art, illustrated in FIGS. 1 and 2, comprises at least one station 12 for supplying tobacco plants, a station 14 for discharging leaves separated from stems, and means 16 for transferring plants from the supply station to the discharging station 14, whereby means 18 for separating leaves are inserted between the supply station and said discharging station.

This first leaf-stripping device provides an effective solution to the sorting of leaves at the discharging station using preparation means with leaf-stripping comprising means for orienting leaves in the same direction and guide means designed to collect the leaves of the same foliar stage.

However, this first leaf-stripping device of the prior art has one drawback: it requires manual loading of the plants at the supply station of the device by an operator 20, shown in dotted lines in FIG. 1, whereby the tobacco plants are loaded individually by said individual, i.e., one plant brought in after the next to be deposited on the transfer means 16.

With the transfer means 16 comprising at least one carrousel in the form of a closed-chain conveyor supporting bars equipped with hooks for receiving tobacco plants, this loading mode imposes an intermittent operation on the leaf-stripping device 10, whereby the transfer means 16 have to be stopped or slowed down to make it possible for the operator 20 to deposit each tobacco plant on the hooks of a bar.

Gradually, the production goals of the tobacco producers have increased, and if the old automated leaf-stripping devices of the prior art offered speeds of approximately 1,000 plants per hour, a device such as the one that is described in French Patent Application FR 08 55200 makes it possible to exceed 2,000 plants per hour.

Although advantageous in terms of output, this high speed is difficult and even impossible to maintain for an individual who is responsible for manually supplying the leaf-stripping device: the plant-loading frequency becoming too difficult and tiring.

A second leaf-stripping device of the prior art, described in the French Patent Application published under Number FR 2 786 991, provides a device for loading tobacco plants placed upstream from the means for separation of the leaves, whereby this loading device consists of guides pitched downward and receiving the tobacco plants in horizontal position and with dangling leaves.

Said loading device therefore makes it possible to deposit several tobacco plants simultaneously on standby at the supply station of this second leaf-stripping device of the prior art.

However, the buffer loading offered by the guides of this loading device is very limited, several plants at the very most.

This buffer loading capacity is not satisfactory in the case of a leaf-stripping device that works at high speed, in particular stripping leaves from more than 2,000 plants per hour, because it does not sufficiently ease the task of the individual responsible for supplying the leaf-stripping device with tobacco plants.

In addition, said plants are stored one after the other without separation and therefore with the risk of sticking together under the action of the vibrations of the leaf-stripping device.

Also, two tobacco plants can become hooked on one another or be too close or be conveyed simultaneously toward the means for separating the leaves.

In this case that is depicted, either the leaf-stripping device is stopped to eliminate this operating defect, or said means for conveying or separating may be damaged.

It is therefore an objective of this invention to remedy the drawbacks of the devices of the prior art by proposing a device for supplying a leaf-stripping device that allows a reliable and ordered supply of tobacco plants and that facilitates the work of the individual ensuring the loading of the tobacco plants to make a leaf-stripping device work at high speed, for example at more than 2,000 plants per hour.

For this purpose, the invention has as its object a device for supplying a leaf-stripping device with tobacco plants, where each plant is composed of a stem bearing leaves, whereby said leaf-stripping device comprises at least one station for supplying tobacco plants, a discharging station, and means for transferring said plants from the supply station to the discharging station according to a direction of work, whereby said transfer means comprise means for receiving plants at the supply station, whereby said supply device is characterized in that it comprises means for depositing said tobacco plants on the means for receiving the leaf-stripping device, and wherein it comprises means for bringing the plants whose leaves are to be stripped one after the other and in an automated manner to the supply station of the leaf-stripping device.

Other characteristics and advantages will emerge from the following description of the invention, a description that is provided only by way of example relative to the accompanying drawings in which:

FIG. 1 shows a view of the supply station of a leaf-stripping device according to the prior art,

FIG. 2 shows a view of the discharging station of a leaf-stripping device according to the prior art,

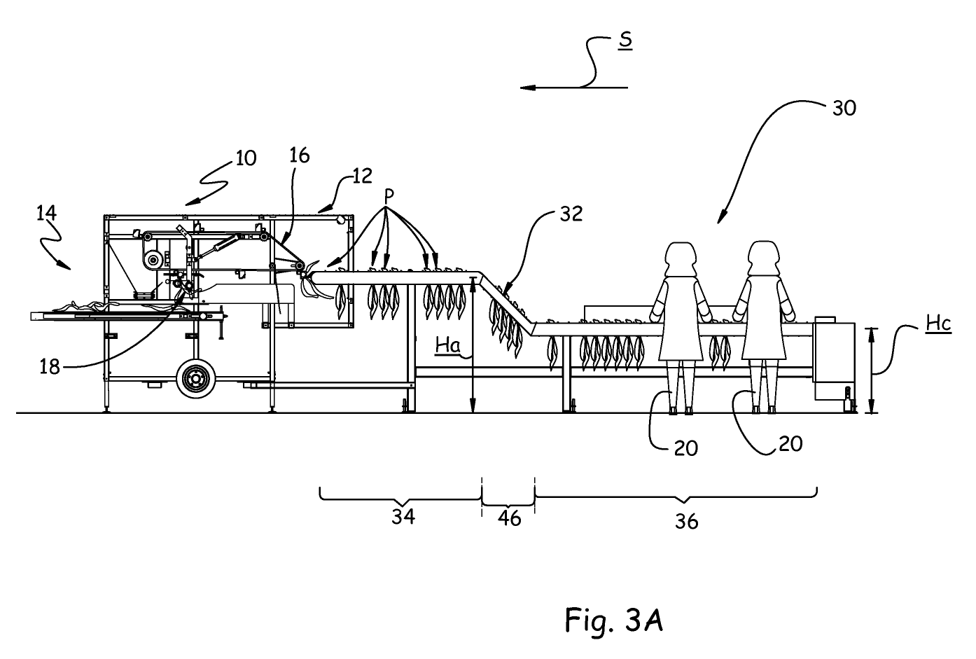

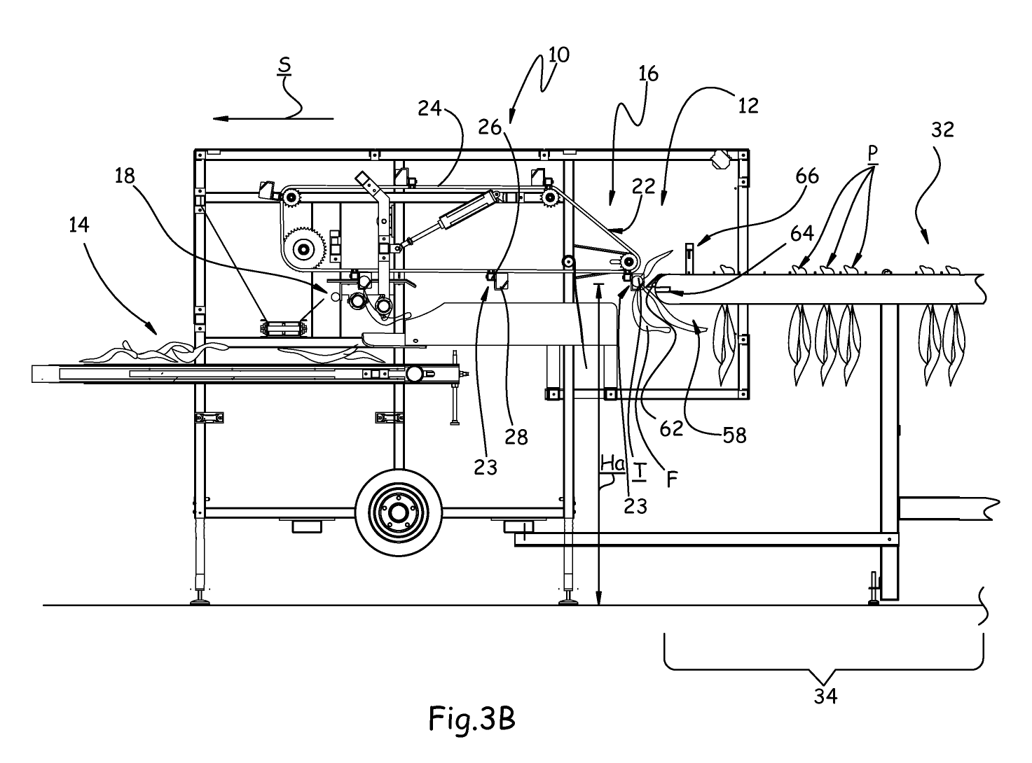

FIG. 3A shows a side view of the device for supplying tobacco plants according to the invention,

FIG. 3B is a detail view of the side view of the device for supplying tobacco plants according to the invention and illustrated in FIG. 3A,

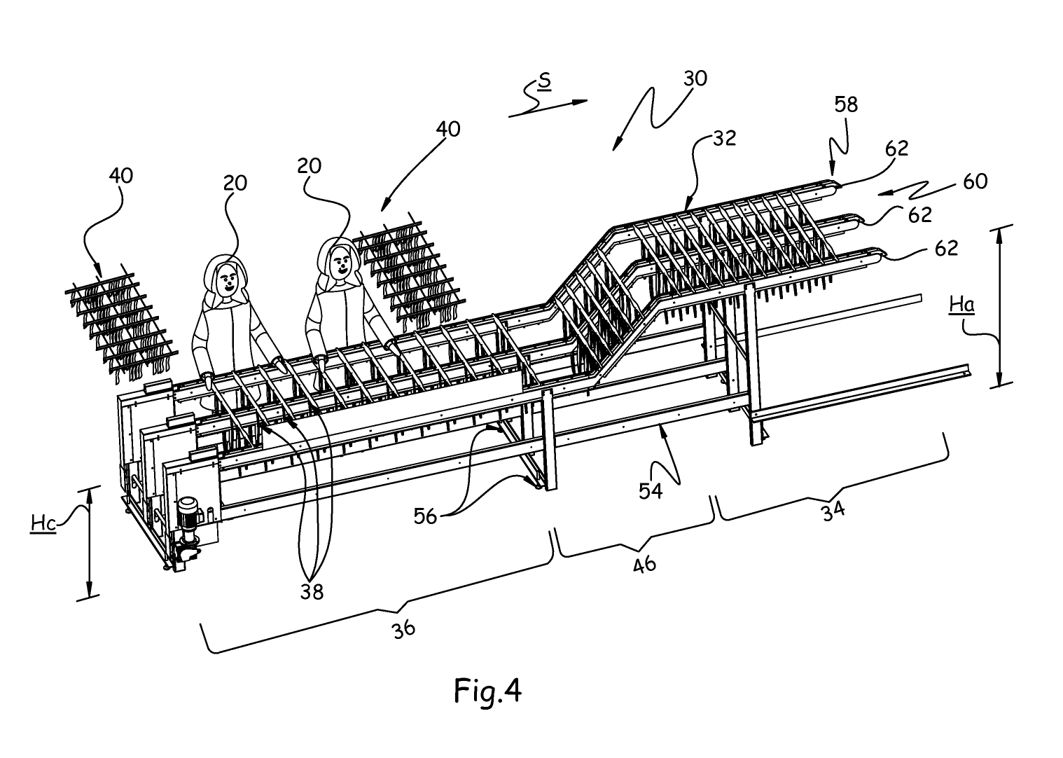

FIG. 4 shows a perspective view of the device for supplying tobacco plants according to the invention,

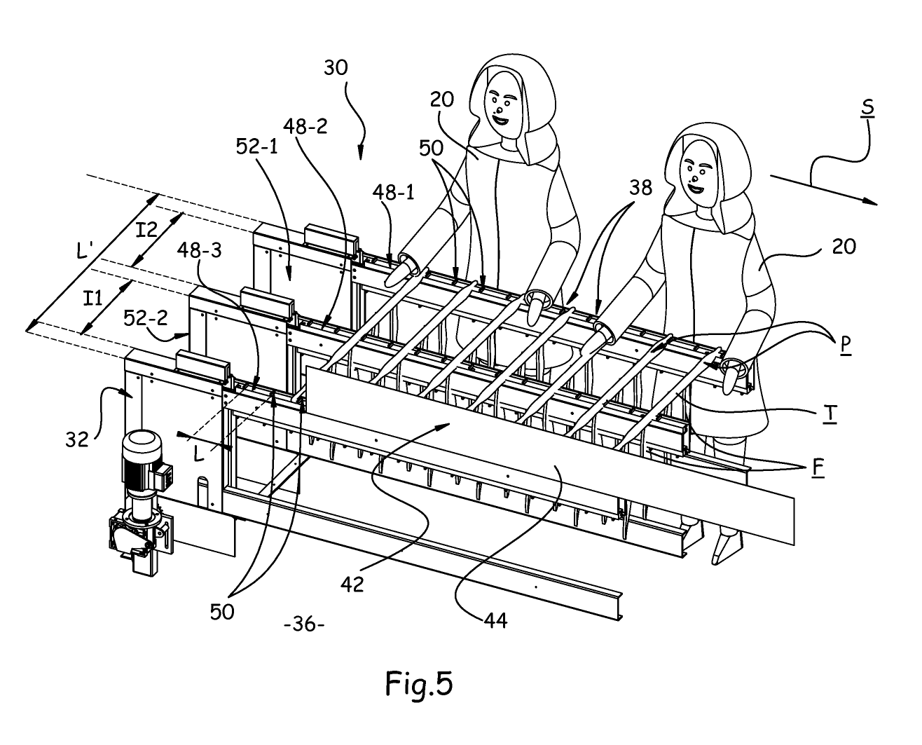

FIG. 5 shows a detailed view of the area for loading the device for supplying tobacco plants according to the invention,

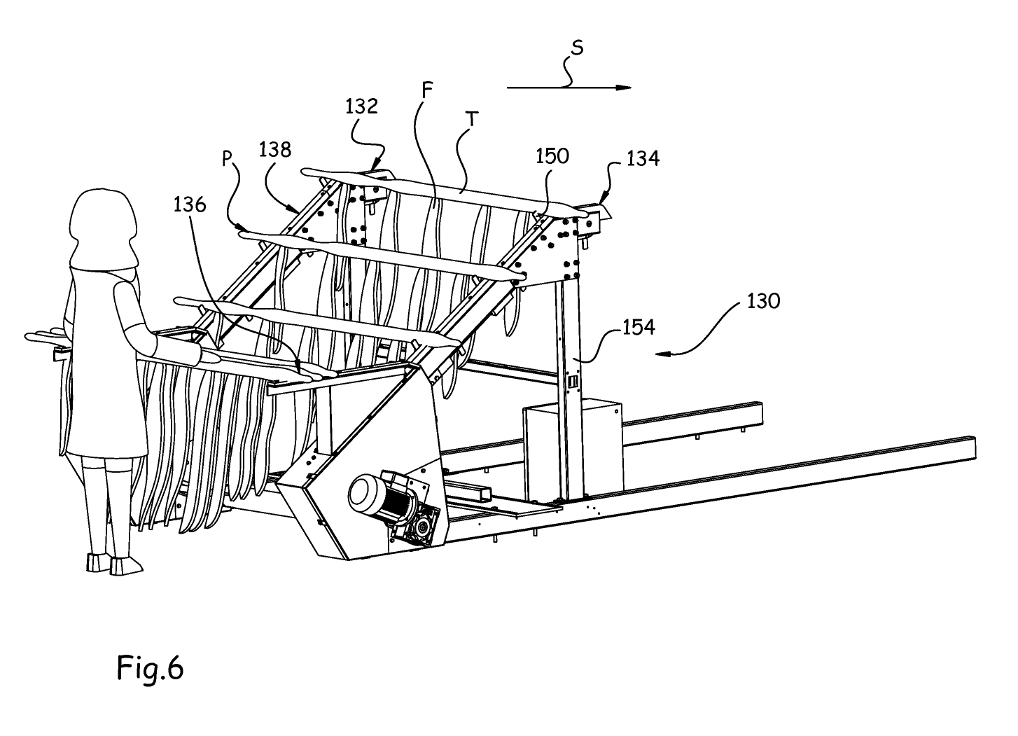

FIG. 6 shows a view of a simplified supply device for movable units in particular,

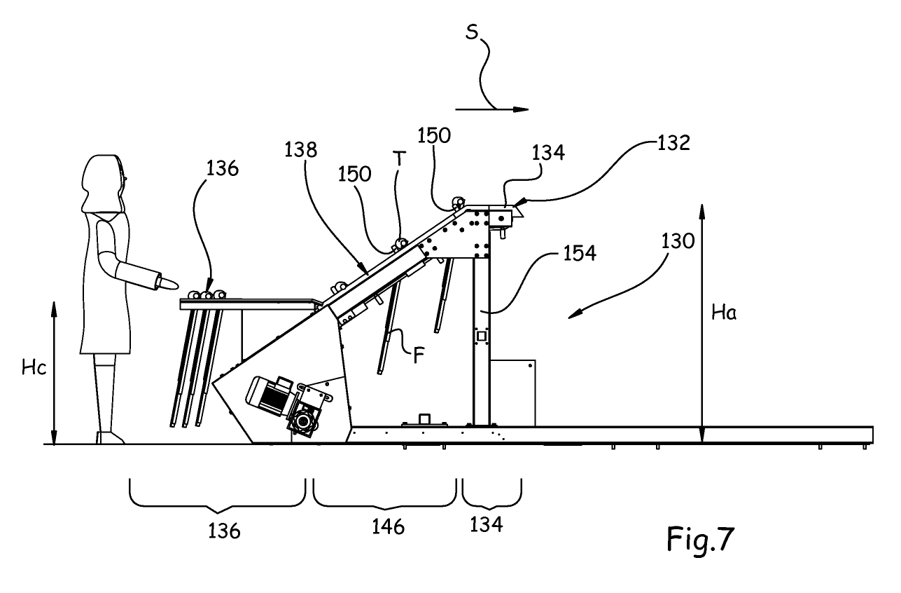

FIG. 7 shows a lateral elevation view of the device of FIG. 6.

This invention is designed for supplying a leaf-stripping device with tobacco plants P, where each device is composed of a stem T that bears leaves F.

More particularly, the supply device according to the invention is designed to supply a leaf-stripping device with transverse loading such as the one that is described in the preamble and shown in a more detailed manner in FIGS. 3A and 3B.

Thus, such a leaf-stripping device 10 comprises at least one supply station 12 of tobacco plants P, a station 14 for discharging leaves F that are separated from stems T, means 16 for transferring said plants from the supply station to the discharging station 14, and means 18 for separating the leaves being inserted between said supply station 12 and said discharging station.

The direction of movement of the tobacco plants P and more generally the direction of work is referenced S.

By way of example, the transfer means 16 comprise at least one carrousel 22 in the form of a closed-chain conveyor 24, one on each side of the leaf-stripping device 10.

At the supply station 12, said carrousel 22 comprises means 23 for receiving plants P in the form of bars 26 that are arranged crosswise to the direction S and suspended by their ends, from each side, at each of the chains of the conveyor 24, whereby these bars extend over the entire width of the leaf-stripping device 10.

Each bar 26 of the receiving means 23 comprises several hooks 28 for receiving stems T of the plants P, and each bar 26 moves in the direction S for the lower strand of the chain.

More specifically, each hook 28 is open toward the supply station so as to receive a plant P and more particularly the stem T of this plant, whereby said plant is oriented crosswise relative to the direction of movement S, i.e., parallel to the bar 26 that supports said hooks 28.

Consequently, the supply device 30 according to the invention comprises means for depositing said tobacco plants P, and more particularly their stem T, on the receiving means 23 of the transfer means 16 of a leaf-stripping device 10 with transverse loading at its supply station 12.

For this purpose, the supply device 30 comprises means for bringing—in the direction S of work, corresponding to the direction of supply—the plants P whose leaves are to be stripped one after the next and in an automated manner to the supply station 12 of a transversely-loaded leaf-stripping device 10.

For this purpose, and as shown in FIGS. 3A and 3B, said means for bringing in and depositing the plants P from device 30 comprise at least one conveyor 32 with at least one supply area 34 located approximately at a supply height Ha that is suitable for depositing the plants P at the height of the receiving means 23 of the transfer means 16 of the leaf-stripping device 10, and at least one loading area 36 with a loading height Hc that can receive several tobacco plants P simultaneously and in an ordered manner, and on which one or more operators 20 deposit the plants P.

Preferably, said conveyor 32 transports the plants P crosswise in the direction S of work, in particular so that said plants P arrive essentially parallel relative to the bars 26 of the receiving means 23 of the leaf-stripping device 10.

To facilitate the work of the operators 20, the loading area 36 of the conveyor 32 is placed at a height Hc that is between 0.8 and 1.2 meters corresponding to a convenient height for depositing plants P, i.e., immediately within reach of an operator 20 and so as to limit his movement of loading plants P.

Advantageously, as illustrated in FIGS. 4 and 5, the conveyor 32 offers several juxtaposed transfer locations 38, separated from one another and driven in translation at a transfer speed V in the direction S of work.

The width L of each transfer location 38 and the transfer speed V are suitable for making several simultaneously accessible locations 38 within reach of an operator 20 at said loading area 36.

In addition, the locations 38 have a width L that is considerably greater than the mean diameter of a stem T of a tobacco plant P.

To provide an estimate, a transfer location 38 has a width that is between ten centimeters and twenty centimeters, the transfer speed V is between 0.05 meter per second and 0.4 meter per second, and the loading area 36 offers about 30 transfer locations 38.

Thus, in the same movement, the operator 20 can deposit several plants P in an ordered manner into said moving locations 38 of said loading area 36, whereby each location 38 is designed to accommodate a plant P.

As FIG. 4 shows, the operator(s) 20 stand(s) before the loading area 36, and each operator 20 uses a zone 40 for supplying tobacco plants P close to the loading area 36, and the operator(s) 20 simply has/have to transfer said plants P that are stored or are arriving at the zone 40 to the loading area 36.

The supply zone 40 can correspond to a storage location or to an inlet of a supply conveyor.

In one preferred embodiment of the invention, the conveyor 32 transfers the tobacco plants P crosswise to the direction S of work, the transfer locations 38 therefore have their width L that is essentially parallel to the direction S of work and a length L′ that is essentially perpendicular to said direction S.

Advantageously, the length L′ of the transfer locations 38 of the conveyor 32 is adapted to the mean length of a stem T of a tobacco plant P, whereby said length L′ is therefore between 0.5 meter and 2 meters to provide an estimate.

In one preferred embodiment of the invention, the tobacco plants P are transported essentially horizontally via the conveyor 32, whereby the transfer locations 38 are therefore essentially horizontal.

However, in one variant embodiment, the loading area 36 can be pitched relative to the horizontal and in a plane that is crosswise to the direction S of work, this facilitating the loading of the plants P by the operators 20 in the loading area 36.

Still within a variant embodiment, the supply area 34 can also be pitched relative to the horizontal and in a plane that is crosswise to the direction S of work, this for adapting to, for example, the angle of the receiving means 23 of the leaf-stripping device 10.

Still so as to facilitate the work of the operators 20, the loading area 36 can be equipped with a stop 42 in the form of a plate 44 that is placed to the right and at one end of the length L′ of the locations 38, whereby this stop 42 makes possible the quick positioning of the plants P on said locations 38 by defining a reference position during the loading of said plants.

Finally, whereby the loading height Hc can be different from the supply height Ha, an inclined area 46 connects the loading area 36 and the supply area 34 in the continuous surface of the conveyor 32.

In the case that is shown in the figures where the supply height Ha is greater than the loading height Hc, the inclined area 46 is therefore ascending in the direction S of work.

In a preferred embodiment of the invention that is nonlimiting and illustrated in FIGS. 4 and 5, the conveyor 32 takes the form of at least three chains (48-1, 48-2, and 48-3) that are essentially parallel in the direction S of work.

Of course, one embodiment of the conveyor 32 with one or two chains 48 can also be considered and is therefore covered by the invention.

Said chains (48-1, 48-2, and 48-3) are closed and driven in a synchronized manner by at least one motor 51, in particular electric, using suitable means for transmission and guiding such as pinions.

Said chains (48-1, 48-2, and 48-3) are equipped with wedges 50 that delimit the transfer locations 38, whereby the wedges 50 of a chain 48 are aligned with the wedges 50 of another chain 48.

Thus, the wedges 50 of a chain (48-1, 48-2, and 48-3) are uniformly spaced and define the width L of said locations 38.

Advantageously, the empty volumes 52-1 and 52-2, corresponding to the spacing intervals I1 and I2 between each chain (48-1, 48-2, and 48-3) taken in the length L′ of the locations 38, make it possible to allow the leaves F of the tobacco plants P that are transported to the locations 38 to dangle.

All of the elements that form said conveyor 32 rest on a frame 54 that is in particular metal and mechanically welded and able to use height-adjustable ground supports 56.

Advantageously, whereby the plants P are deposited quickly on the locations 38 with width L that is considerably larger than the mean diameter of a stem T of a tobacco plant P, during the passage of the plants P at the inclined area 46 and ascending from the conveyor 32, said plants P settle by gravity on the wedges 50 that are located to the rear of the location 38 in the direction S of work.

Thus, at the supply area 34 of the conveyor 32, said plants P all arrive automatically settled on the wedge 50 behind their location 38, uniformly spaced and in a position that is defined relative to said chains 48.

This uniform and precise positioning of the plants P relative to the chains 48 that form the conveyor 32 allows controlled guiding of the supply of tobacco plants P to the leaf-stripping device 10 that is located downstream from the supply device 30.

So as to supply tobacco plants P to the receiving means 23 of the leaf-stripping device 10, at the end 58 of the supply area 34, the conveyor 32 comprises means 60 for unloading plants P that are suitable for said receiving means 23.

In a preferred embodiment, said unloading means 60 take the form of at least one downward slat 62 around which each chain 48 winds and returns at the end 58 of the supply area 34.

Thus, said plants P are simply unloaded by gravity into the receiving means 23 that are joined to said slats 62, as is illustrated in FIG. 3B.

So as to guide the unloading of plants P in agreement with the operation of the leaf-stripping device 10, and more particularly its transfer means 16, the conveyor 32 according to the invention is equipped with at least one position sensor 64 that detects the position of wedges 50 of a chain 48 and a sensor 66 of the presence of a plant P in a location 38 at the end 58 of the supply area 34.

Said presence sensor 66 is preferably located at unloading means 60 of the plants P, right at the transfer site toward the leaf-stripping device 10.

Thus, using information provided by said presence sensors 66 and position sensors 64, the motor 51 and therefore the transfer speed V of the conveyor 32 can be controlled to supply the leaf-stripping device in an optimal manner, the position sensor 64 indirectly indicating the position of the tobacco plants P because of the adjustment of said plants on the wedges 50 behind each location 38, and the presence sensor 66 confirming that a tobacco plant P is ready to be unloaded.

Of course, the guiding of the transfer speed V of the conveyor 32 is also done based on the speed of the transfer means 16 of the leaf-stripping device 10 that is supplied.

Thus, more generally, according to the design and the operating mode of a leaf-stripping device 10 that is supplied by the device 30 according to the invention, the transfer speed V of the conveyor can be continuous or intermittent.

In one improved embodiment of the supply device 30 according to the invention, means for treating leaves F of plants P can be arranged along the conveyor 32 to improve the subsequent leaf-stripping, such as, for example, brushes or blowers.

Also, it is obvious that the supply device according to this invention can be adapted to a leaf-stripping device with longitudinal loading of tobacco plants; in particular, it is enough for suitable transfer means to be added between the supply device as it was just described and said leaf-stripping device with longitudinal loading.

Of course, the supply device according to this invention is not limited to the embodiment that was just described, whereby the variants that relate to the production of the conveyor 32 and location 38 are covered by the invention. Thus, FIGS. 6 and 7 show an arrangement with a supply device that is more compact and suitable for lower speeds, more particularly for supplying movable devices that are designed to be transported to production sites so as to carry out leaf-stripping operations in situ.

For the description of this variant, the references of identical elements bear the same references increased by 100, except for the references that pertain to the leaf-stripping machine, which are preserved, whereby the leaf-stripping machines have only different work capacities.

Thus, in FIGS. 6 and 7, the supply device 130 comprises means for bringing into the direction S of work, corresponding to the direction of supply of a leaf-stripping machine 10, the plants P to be stripped of their leaves one after the other and in an automated manner at the supply station 12 of a leaf-stripping device 10 with transverse loading.

For this purpose, and as shown in FIGS. 6 and 7, said means for bringing in and depositing the plants P of the device 130 comprise at least one conveyor 132 with at least one supply area 134 that is located essentially at a supply height Ha that is suitable for depositing the plants P at the height of the receiving means 23 of the leaf-stripping device 10, and at least one loading area 136 of loading height Hc that can receive several tobacco plants P simultaneously.

Preferably, said conveyor 132 conveys the plants P crosswise in the direction S of work, in particular so that said plants P reach—essentially parallel relative to the bars 26—receiving means 23 of the leaf-stripping device 10, as above.

The loading area 136 of the conveyor 132 is arranged at a height Hc of between 0.8 and 1.2 meters corresponding to a convenient height for depositing plants P, as in the preceding variant.

Advantageously, as illustrated in FIGS. 6 and 7, the conveyor 132 offers several juxtaposed transfer locations 138, separated from one another, and driven in translation at a transfer speed V in the direction S of work.

In the case that is shown in the figures where the supply height Ha is greater than the loading height Hc, the inclined area 146 is therefore ascending in the direction S of work.

The chains, wedges 150 are identical to the preceding embodiment.

All of the elements that form said conveyor 132 rest on a frame 154 that is in particular metal and mechanically welded and able to be made integral with the leaf-stripping device 10 with a height adjustment.

This arrangement makes it possible to move an entire leaf-stripping device unit that is equipped with wheels by rolling from one operation to the next, but also to connect a supply so that even in smaller operations, working comfort is preserved.

1. Supply device (30, 130) of a device (10) for stripping leaves from tobacco plants P, where each plant is composed of a stem T that bears leaves F, whereby said leaf-stripping device (10) comprises at least one station (12) for supplying tobacco plants P, a discharging station (14), and means (16) for transferring said plants P from the supply station (12) to the discharging station (14) according to a direction S of work, whereby said transfer means (16) comprise means (23) for receiving plants P at the supply station (12), whereby said supply device (30, 130) is characterized in that it comprises means for depositing said tobacco plants P on the receiving means (23) of the leaf-stripping device (10), and wherein it comprises means for bringing the plants P whose leaves are to be stripped one after the other and in an automated manner to the supply station (12) of the leaf-stripping device.

2. Supply device (30) of a device (10) for stripping leaves from tobacco plants P, where each plant is composed of a stem T that bears leaves F according to claim 1, wherein the means for bringing in and depositing the plants P comprise at least one conveyor (32, 132) with at least one supply area (34, 134) that is located at a supply height Ha that is suitable for depositing the plants P at the height of the receiving means (23) of the leaf-stripping device (10), and at least one loading area (36, 136) with a loading height Hc that can receive several tobacco plants P.

3. Supply device (30) of a device (10) for stripping leaves from tobacco plants P, where each plant is composed of a stem T that bears leaves F according to claim 1, wherein it comprises at least one conveyor (32, 132) that offers several juxtaposed transfer locations (38, 138) that are separated from one another and driven in translation at a transfer speed V in the direction S of work.

4. Supply device (30) of a device (10) for stripping leaves from tobacco plants P, where each plant is composed of a stem T that bears leaves F according to claim 3, wherein the locations (38, 138) have a width L that is considerably larger than the mean diameter of a stem T of a tobacco plant P.

5. Supply device (30) of a device (10) for stripping leaves from tobacco plants P, where each plant is composed of a stem T that bears leaves F according to claim 4, wherein the conveyor (32, 132) transfers the tobacco plants P crosswise to the direction S of work, whereby the transfer locations (38) have their width L parallel to the direction S of work and a length L′ that is perpendicular to said direction S.

6. Supply device (30) of a device (10) for stripping leaves from tobacco plants P, where each plant is composed of a stem T that bears leaves F according to claim 5, wherein the loading area (36, 136) is horizontal in a plane that is crosswise to the direction S of work.

7. Supply device (30) of a device (10) for stripping leaves from tobacco plants P, where each plant is composed of a stem T that bears leaves F according to claim 6, wherein the loading area (36) is equipped with a stop (42) in the form of a plate (44) that is arranged to the right and at one end of the length L′ of the locations (38).

8. Supply device (30) of a device (10) for stripping leaves from tobacco plants P, where each plant is composed of a stem T that bears leaves F according to claim 7, wherein the conveyor (32) takes the form of at least three parallel chains (48-1, 48-2, and 48-3) in the direction S of work, closed and driven in a synchronized manner by at least one motor (51).

9. Supply device (30) of a device (10) for stripping leaves from tobacco plants P, where each plant is composed of a stem T that bears leaves F according to claim 8, wherein the chains (48-1, 48-2, and 48-3) are equipped with wedges (50) that delimit the transfer locations (38), whereby the wedges (50) of a chain (48) are aligned with the wedges (50) of another chain (48).

10. Supply device (30) of a device (10) for stripping leaves from tobacco plants P, where each plant is composed of a stem T that bears leaves F according to claim 8, wherein the conveyor (32) comprises means (60) for unloading plants P that are suitable for said receiving means (23).

11. Supply device (30) of a device (10) for stripping leaves from tobacco plants P, where each plant is composed of a stem T that bears leaves F according to claim 10, wherein said unloading means (60) take the form of at least one downward slat (62) around which each chain (48) winds and returns at the end (58) of the supply area (34).

12. Supply device (30) of a device (10) for stripping leaves from tobacco plants P, where each plant is composed of a stem T that bears leaves F according to claim 9, wherein the conveyor (32) is equipped with at least one position sensor (64) that detects the position of the wedges (50) of a chain (48) and a sensor (66) of the presence of a plant (P) in a location (38) at the end (58) of the supply area (34).

13. Supply device (30) of a device (10) for stripping leaves from tobacco plants P, where each plant is composed of a stem T that bears leaves F according to claim 2, wherein it comprises at least one conveyor (32, 132) that offers several juxtaposed transfer locations (38, 138) that are separated from one another and driven in translation at a transfer speed V in the direction S of work.

14. device (30) of a device (10) for stripping leaves from tobacco plants P, where each plant is composed of a stem T that bears leaves F according to claim 13, wherein the locations (38, 138) have a width L that is considerably larger than the mean diameter of a stem T of a tobacco plant P.

15. Supply device (30) of a device (10) for stripping leaves from tobacco plants P, where each plant is composed of a stem T that bears leaves F according to claim 9, wherein the conveyor (32) comprises means (60) for unloading plants P that are suitable for said receiving means (23).

16. Supply device (30) of a device (10) for stripping leaves from tobacco plants P, where each plant is composed of a stem T that bears leaves F according to claim 15, wherein said unloading means (60) take the form of at least one downward slat (62) around which each chain (48) winds and returns at the end (58) of the supply area (34).

17. Supply device (30) of a device (10) for stripping leaves from tobacco plants P, where each plant is composed of a stem T that bears leaves F according to claim 10, wherein the conveyor (32) is equipped with at least one position sensor (64) that detects the position of the wedges (50) of a chain (48) and a sensor (66) of the presence of a plant (P) in a location (38) at the end (58) of the supply area (34).

18. Supply device (30) of a device (10) for stripping leaves from tobacco plants P, where each plant is composed of a stem T that bears leaves F according to claim 11, wherein the conveyor (32) is equipped with at least one position sensor (64) that detects the position of the wedges (50) of a chain (48) and a sensor (66) of the presence of a plant (P) in a location (38) at the end (58) of the supply area (34).
